(19) United States
(12) Patent Application Publication
(10) Pub. No.: US 2006/0233627 A1
(43) Pub. Date: Oct. 19, 2006

(54) Seal washer

(76) Inventor: Leslie J. Weinstein, Boise, ID (US)

Correspondence Address: Joseph W. Holland;Holland & Midgley, LLP, P.O. Box 1840, Boise, ID, 83701-1840, US

(21) Appl. No.: 11/089,724

(22) Filed: Mar. 23, 2005

(51) Int. Cl. F16B 33/00

(52) U.S. Cl. 411/369

(57) ABSTRACT

A seal washer and a locknut assembly for retaining for instance a wheel on a shaft, the locknut assembly seal washer. The seal washer includes a cylindrical segment connected to and extending from an outer peripheral edge of the washer section, the cylindrical segment. The seal washer includes an outer seal contact surface. The locknut assembly also includes a nut having an annular portion, an anti-rotation member cooperative with the shaft and the nut, the anti-rotation member adapted to prevent rotation of the nut with respect to the shaft. The locknut assembly also includes a seal washer including a washer section and a cylindrical segment connected to and extending from an outer peripheral edge of the washer section, the cylindrical segment including an outer seal contact surface.

### BACKGROUND OF THE INVENTION

1. Technical Field

The present invention relates generally to fasteners and more particularly to a seal washer for including an outer seal contact surface.

2. Background

A wheel assembly commonly includes a wheel or other rotation member mounted to a shaft. A locknut assembly may be used to secure a rotation member on the shaft, spindle, axle or other member. One such locknut assembly is disclosed in U.S. Pat. No. 6,095,735 to Weinstein, entitled Locking Nut Assembly, which is incorporated by reference herein. In many cases, the wheel assembly includes one or more bearing assemblies for reducing friction between the shaft and the wheel or other rotation member. Additionally, the wheel assembly may include one or more seals that serve to limit entry of foreign matter and moisture between the shaft and the wheel or other rotation member or into the bearing assemblies. The seals also serve to limit loss of lubricant from the bearing assemblies. The seal is typically positioned on a land that is recessed with respect to the surrounding structure of the wheel or other rotation member. The recessed land includes an outer sidewall that provides a contact surface for the seal outer peripheral surface. In those instances wherein the wheel or other rotation member is configured such that the seal is substantially flush with the locknut assembly, there is no bearing surface against which an inner peripheral surface of the seal might bear or abut. As such, there may be an increased probability for entry of foreign matter between the shaft and the wheel or other rotation member or into the bearing assemblies at the inner peripheral surface of the seal.

Advantage may therefore be found in providing a washer for use with the locknut assembly that includes a seal contact surface against which contact with the inner peripheral surface of the seal could be maintained.

It is therefore a general objective of the present invention to provide a seal washer including a seal contact surface against which contact with the inner peripheral surface of the seal could be maintained.

### SUMMARY OF THE INVENTION

The present invention is directed to a seal washer including a washer section and a cylindrical segment connected to and extending from an outer peripheral edge of the washer section, the cylindrical segment including an outer seal contact surface. Preferably, the cylindrical segment of the seal washer extends from the washer section having an orientation characterized as substantially perpendicular to the outer peripheral edge of the washer section. Preferably, the cylindrical segment of the seal washer may be configured as a substantially cylindrical segment.

The present invention is also directed to a locknut assembly for retaining a rotation member on a shaft, the rotation member including a seal positioned in a center mounting aperture of the rotation member. The locknut assembly includes a nut having an annular portion, an anti-rotation member cooperative with the shaft and the nut, the anti-rotation member adapted to prevent rotation of the nut with respect to the shaft. The locknut assembly also includes a seal washer including a washer section and a cylindrical segment connected to and extending from an outer peripheral edge of the washer section, the cylindrical segment including an outer seal contact surface.

The present invention is also directed to a hub assembly including a shaft and a rotation member mounted on the shaft. The rotation member includes a seal positioned in a mounting aperture located in the rotation member. A seal washer is disposed on the shaft and a nut is threaded onto the shaft securing seal washer the rotation member in a selected the shaft and an anti-rotation member, cooperative with the shaft and the nut, is adapted to prevent rotation of the nut with respect to the shaft. In one preferred embodiment, the rotation member is configured as a wheel having a pneumatic tire mounted thereto. The wheel is mounted to a fixed shaft and rotates with respect to the fixed shaft.

Additional advantages and novel features of the invention will be set forth in part in the description that follows, and in part will become apparent to those skilled in the art upon examination of the following, or may be learned by practice of the invention. Additionally, the advantages of the invention may be realized and attained by means of the instrumentalities and combinations particularly pointed out in the appended claims.

### BRIEF DESCRIPTION OF DRAWINGS

FIG. 1 is a representative perspective view of an aircraft including a landing gear having a wheel assembly;

FIG. 2 is a representative cutaway sectional view of a wheel assembly including a seal washer according to the present invention;

FIG. 3 is a representative exploded perspective view of a locknut assembly including a seal washer according to the present invention;

FIG. 4 is a representative partial sectional view of a wheel assembly including a seal washer according to the present invention; and

FIG. 5 is a representative partial detail sectional view of a locknut assembly including a seal washer according to the present invention.

### DETAILED DESCRIPTION OF THE INVENTION

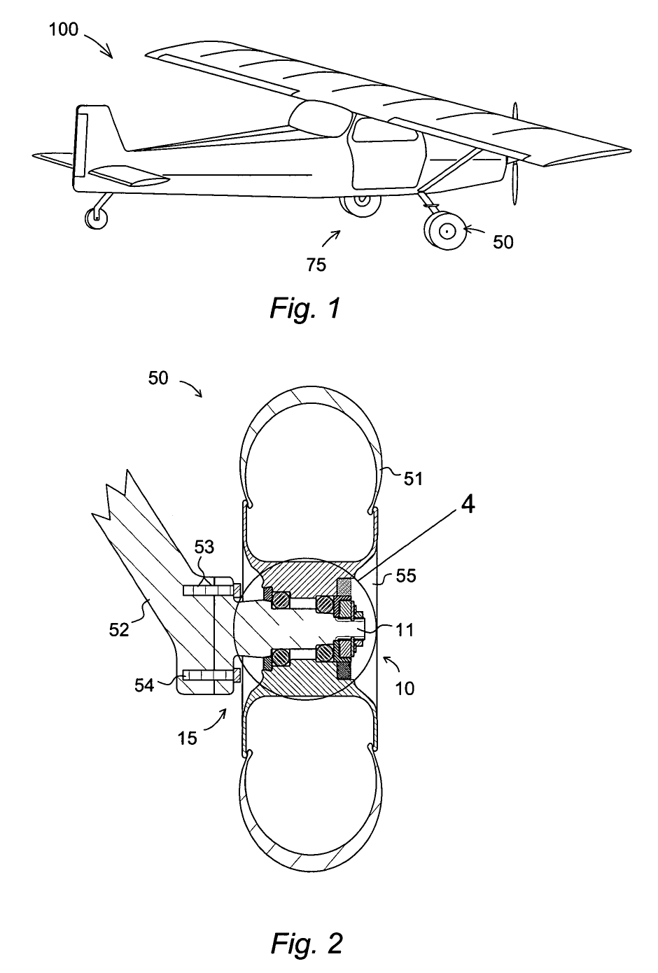

FIG. 1 is a representative perspective view of an aircraft 100 including a landing gear 75 including a wheel assembly 50. FIG. 2 is a representative cutaway sectional view of wheel assembly 50 including tire 51 mounted to wheel 55. Stub axle 15 includes shaft 11 fastened to strut arm 52 by screws 53 and 54. Locknut assembly 10 secures wheel 55 to shaft 11.

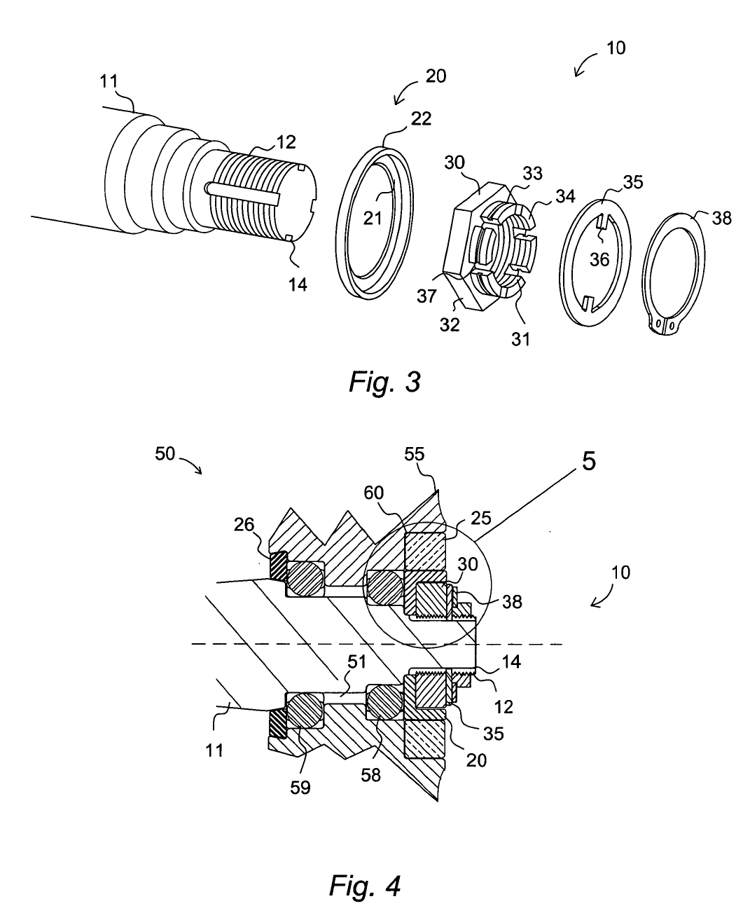

Referring to FIG. 3, an exploded perspective view of locknut assembly 10 and shaft 11. Locknut assembly 10 includes seal washer 20, nut 30, lock washer 35 and retainer clip 38. Seal washer 20 includes washer section 21 and cylindrical segment 22 connected to and extending from an outer peripheral edge of washer section 21. Shaft 11 includes longitudinally extending channel 14 and thread 12 cut along shaft 11 for engaging internal thread 31 of nut 30.

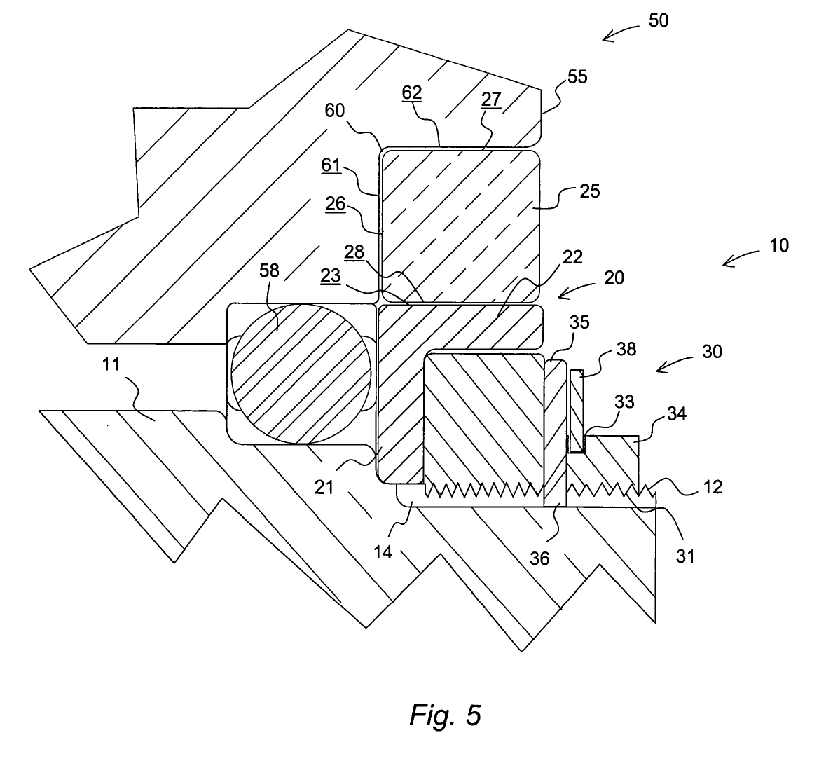

Nut 30 includes a hex-shaped torque-surface 32 and upper castle portion 34. Retainer groove 33 extends around an annular portion of upper castle portion 34. In the preferred embodiment, shown in FIGS. 3 and 4, an anti-rotation member is configured as tab 36 of lock washer 35 which is adapted to pass through one of the plurality of channels 37 of nut 30 to engage channel 14 of shaft 11. As shown, locknut assembly 10 also includes retainer 38 which is engageable within retainer groove 33.

Referring to FIG. 4, a partial cutaway view of wheel assembly 50 is shown including locknut assembly 10 and shaft 11. Locknut assembly 10 includes seal washer 20, nut 30, lock washer 35 and retainer clip 38. Shaft 11 includes thread 12 cut along shaft 11 for engaging nut 30.

Mounting aperture 51 of wheel 55 is positioned about shaft 11 and front and rear bearings 58 and 59 respectively provide reduced friction between wheel 55 and shaft 11. Front and rear seals 25 and 26 respectively limit the entry of foreign matter and moisture into an interior of wheel 55. Seal 25 is shown positioned in seal race 60 which includes a land portion 61 and an outer seal face contact surface 62.

Referring to FIG. 5, a partial cutaway view of wheel assembly 50 is shown including locknut assembly 10 and shaft 11. Locknut assembly 10 includes seal washer 20, nut 30, lock washer 35 and retainer clip 38. Shaft 11 includes longitudinally extending channel 14 and thread 12 cut along shaft 11 for engaging internal thread 31 of nut 30. Nut 30 includes upper castle portion 34. Tab 36 of lock washer 35 engages channel 14 of shaft 11. Retainer groove 33 extends around upper castle portion 34 and retainer 38 is positioned in retainer groove 33 to retain lock washer 35 in position.

Wheel 55 is positioned about shaft 11 and front bearing 58 is shown positioned between wheel 55 and shaft 11. Front seal 25 includes land surface 26, outer peripheral surface 27 and inner peripheral surface 28. Front seal 25 is shown positioned between seal washer 20 and wheel 55. More particularly, front seal 25 is shown positioned in seal race 60 which includes a land portion 61 and an outer seal face contact surface 62. Seal washer 20 includes washer section 21 and cylindrical segment 22 connected to and extending from an outer peripheral edge of washer section 21. In the preferred embodiment of the invention, cylindrical segment 22 includes a cylindrical segment extending substantially perpendicular to the outer peripheral edge of the washer section. Also, in the preferred embodiment of the invention, cylindrical segment 22 includes a substantially cylindrical segment. Cylindrical segment 22 includes inner seal contact surface 23 which provides a contact surface for inner peripheral surface 28 of front seal 25.

It is to be understood that the invention is not limited to the embodiment shown and described above. Various other embodiments of the invention may be made and practiced without departing from the scope of the invention, as defined in the following claims.

What is claimed is:

1. A seal washer comprising a washer section and a cylindrical segment connected to and extending from an outer peripheral edge of the washer section, the cylindrical segment including an inner seal contact surface.

2. The seal washer of claim 1 wherein the cylindrical segment further comprises a cylindrical segment extending substantially perpendicular to the outer peripheral edge of the washer section.

3. The seal washer of claim 1 wherein the cylindrical segment further comprises a substantially cylindrical segment.

4. A locknut assembly for retaining a rotation member on a shaft, the rotation member including a seal positioned in a mounting aperture located in the rotation member, the locknut assembly comprising:
a nut having an annular portion;
an anti-rotation member cooperative with the shaft and the nut, the anti-rotation member adapted to prevent rotation of the nut with respect to the shaft; and
a seal washer positioned on the shaft below the nut, the seal washer including a washer section and a cylindrical segment connected to and extending from an outer peripheral edge of the washer section, the cylindrical segment including an inner seal contact surface.

5. The seal washer of claim 4, wherein the cylindrical segment further comprises a cylindrical segment extending substantially perpendicular to the outer peripheral edge of the washer section.

6. The locknut assembly of claim 4 wherein the seal washer cylindrical segment further comprises a substantially cylindrical segment.

7. A hub assembly comprising:
a shaft including a longitudinally extending channel;
a rotation member mounted on the shaft, the rotation member including a seal positioned in a mounting aperture located in the rotation member;
a nut having an annular portion;
a nut anti-rotation member cooperative with the shaft and the nut, the nut anti-rotation member adapted to prevent rotation of the nut with respect to the shaft; and
a seal washer including a washer section and a cylindrical segment connected to and extending from an outer peripheral edge of the washer section, the cylindrical segment including an inner seal contact surface.

8. The seal washer of claim 5, wherein the cylindrical segment further comprises a substantially cylindrical segment.
